(19) United States
(12) Patent Application Publication
(10) Pub. No.: US 2004/0254959 A1
(43) Pub. Date: Dec. 16, 2004

(54) Method and computer system for project portfolio management

(76) Inventors: Karsten Dierksen, Koln (DE); Jurgen Ebbers, Wuppertal (DE); Reinhard Hirsch, Koln (DE); Karsten Malsch, Koln (DE); Volker Mues, Wuppertal (DE); Edgar Ostinning, Krefeld (DE); Ralf Pakull, Pulheim (DE)

Correspondence Address: BAYER MATERIAL SCIENCE LLC, 100 BAYER ROAD, PITTSBURGH, PA, 15205, US

(21) Appl. No.: 10/689,163

(22) Filed: Oct. 20, 2003

(30) Foreign Application Priority Data
Oct. 24, 2002 (DE) 10249482.7

(51) Int. Cl. G06F 17/00; G06F 7/00; G06F 17/60

(52) U.S. Cl. 707/104.1; 705/1

(57) ABSTRACT

A computer-implemented method of performing a risk analysis for a project is described. The computer-implemented method includes, generating, in a hierarchical database, a plurality of area checklists in the form of documents, wherein each area checklist has at least one input field into which data is input. Next, the data from the hierarchical database is exported to a relational database. After completion of the exporting step, the relational database is accessed, and the risk analysis is performed on the data that has been exported into the relational database. The risk analysis results of the project are then outputted.

### CROSS REFERENCE TO RELATED PATENT APPLICATION

The present patent application claims the right of priority under 35 U.S.C. §119 (a)-(d) of German Patent Application No. 102 49 482.7, filed Oct. 24, 2002.

### FIELD OF THE INVENTION

The invention relates to a method of project portfolio management and a corresponding computer system and computer program product.

### BACKGROUND OF THE INVENTION

An essential component of project portfolio management is risk management. From the prior art, numerous risk analysis methods, which typically include qualitative and/or quantitative techniques, are known. With such methods, decision-making is supported by, for example, determining the probability of possible scenarios or providing proposals for prioritisation.

Typical risk analysis methods are often based on or make use of Monte Carlo simulation, decision trees and influence diagrams.

Various risk analysis computer programs are available commercially from, for example, the Palisade Corporation. A risk analysis and simulation add-in may be added to the Microsoft Excel spreadsheet or Lotus 1-2-3 spreadsheet programs by using the @RISK 4.0 risk analysis program (which is commercially available from Palisade Corporation). The @RISK program makes use of Monte Carlo simulation, in which values which are unspecified in the calculation table model are replaced by functions, to represent a range of possible values. In this way, a distribution of possible results and the corresponding probability that each result will occur are obtained. These results are prepared graphically and are output, for example, in the form of histograms, cumulative curves or area and line diagrams.

The computer program @RISK 4 Project (which is commercially available from Palisade Corporation) includes additional functions for project planning. By using them, it is possible to carry out additional extended analyses such as: sensitivity analysis, scenario analysis and critical indices analysis. With sensitivity analysis, the input distributions which have the greatest effect on the outputs may be identified. The results may then be represented in a Tornado diagram, which can easily be analysed.

With scenario analysis, the input combinations are identified which lead to the output target values. Using critical indices, it is possible to establish when a task takes on critical dimensions during a simulation.

Critical tasks (which are identified with critical indices analysis) are tasks for which a critical projection results, i.e., by which the total duration of the project can be established. With critical indices analysis, all critical indices are automatically logged for all tasks as percentage values over time, and thus the critical tasks of a project are identified.

A further example of a program for risk analysis and decision software is available under the name “Adele,” from the Dresden Institute for Decision Analyses (Dresdner Institut für Entscheidungsanalysen).

A common disadvantage of the above-mentioned computer programs, with regard to risk analysis, is that the database for carrying out the analysis cannot be made available efficiently. This disadvantage is evident in particular with distributed projects, which involve different instances and locations in a single company. A further disadvantage relates to the difficulty of maintaining the database, and to adapting the database to the current status of a project.

### SUMMARY OF THE INVENTION

An object of the invention involves providing an improved method of risk analysis and management of project portfolios, and correspondingly an improved computer system (which includes database resources, such as Lotus Notes) and a computer program product (which includes program resources, such as software programs and subroutines).

In accordance with the present invention there is provided a computer-implemented method of performing a risk analysis for a project, comprising:

generating, in a hierarchical database, a plurality of area checklists in the form of documents, each area checklist having at least one input field, and entering data into said input field;

exporting the data from the hierarchical database to a relational database;

accessing the relational database, and performing said risk analysis on the data exported to said relational database; and

outputting risk analysis results for said project.

The features that characterize the present invention are pointed out with particularity in the claims, which are annexed to and form a part of this disclosure. These and other features of the invention, its operating advantages and the specific objects obtained by its use will be more fully understood from the following detailed description and accompanying drawings in which preferred embodiments of the invention are illustrated and described.

### BRIEF DESCRIPTION OF THE DRAWING FIGURES

FIG. 1 is a flow diagram representing a typical operation of a method of risk analysis according to the present invention;

FIG. 2 is a flow diagram representing the risk analysis of a single project in accordance with the present invention;

FIG. 3 is a flow diagram representing the risk analysis of a project portfolio in accordance with the present invention; and

FIG. 4 is a block diagram representing a computer system according to the present invention.

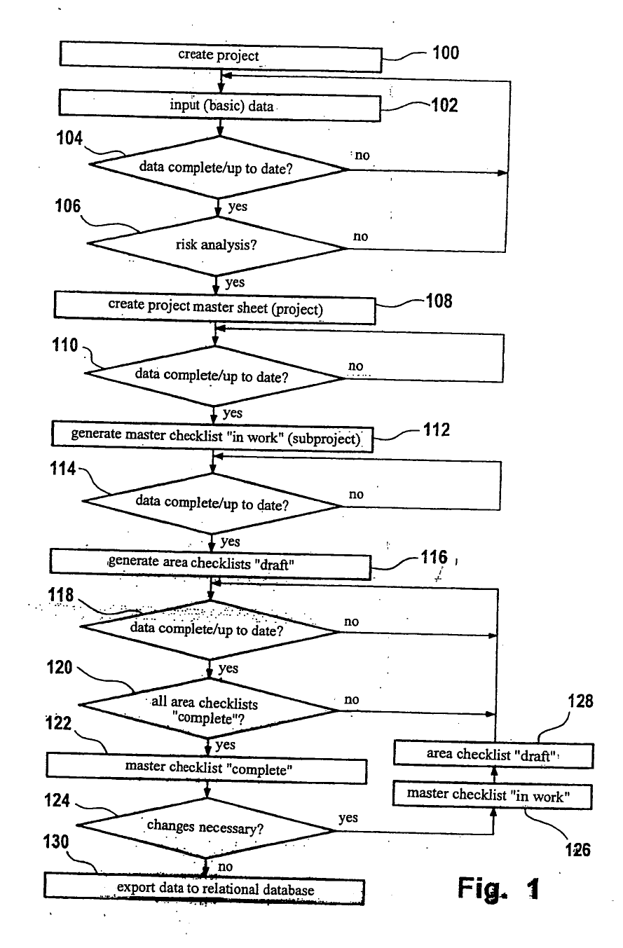

In FIGS. 1 through 4, like reference numerals designate the same operations and components.

### DETAILED DESCRIPTION OF THE INVENTION

The invention makes it possible to include the various company employees who are involved in a project in the data collection for risk analysis. For the functional-area-specific data collection in the company, area checklists which have input fields for entering data for risk analysis are used. For each company functional area which is involved in the project, a specific area checklist is used with input fields for data for which the relevant functional area is to be asked. From the data which is collected in this way, risk analyses results at the project level are produced. From these results, in a further step, a risk analysis of the whole project portfolio is produced.

For example, there may be specific area lists for “research and development”, “regional/strategic marketing”, “production”, “patent law and licences” and “ecology” for a project for development and market introduction of a new chemical product by a chemical industry company.

After the required data has been entered into input fields of all the area checklists and stored in the hierarchical database, the data is then exported from the hierarchical database into a relational database. This is particularly advantageous because a hierarchical database is specially suitable for bringing together data which is spatially distributed. Such a database can preferably be implemented using, for example, Lotus Notes (which is commercially available from Lotus Development Corporation). In this case, the area checklists are Lotus Notes documents.

The Lotus Notes database system follows a flat hierarchical structure. A Lotus Notes document is an autonomous unit, and contains information about the data structure as well as about the data itself. The documents in a Lotus Notes database can therefore have completely different structures, since they are not linked to tables. A further advantage of Lotus Notes is the concept of replication, which simplifies a spatially distributed method of working.

However, a disadvantage of a hierarchical database such as Lotus Notes is that because of the flexible structure of the documents, use of query languages such as SQL is not possible. According to the invention, this disadvantage is removed by exporting the data from the hierarchical database into a relational database, to carry out the calculations and statistical analyses which are required for risk analysis on the basis of the previously collected data. This can then be done at a high processing speed, because access to the data which is stored in the relational database is efficient and fast.

According to another preferred version of the invention, the area checklists have an initial first status and a second status:

All newly created area checklists are initially in “Draft” status. The document status can be changed in an editing mode by clicking on the “Document complete” action button. However, as a precondition of this, all mandatory input fields must first be filled with data, since otherwise the document cannot be stored. The mandatory input fields are preferably marked in colour. The data of the mandatory fields goes into the risk analysis. The additionally collected data provides more information, which is not, or only with great difficulty, accessible to mathematical treatment, about the project environment.

According to another preferred version of the invention, a master checklist is generated. The master checklist is an instance at a higher level than the area checklists. The master checklist has the initial status “Work in progress” and the further status “Complete”. The “Work in progress” state applies as long as at least one of the area checklists is still in “Draft” state. For the master checklist to obtain the “Complete” status, all area checklists which are assigned to the master checklist must include the document status “Document complete”. The status of the master checklist can be changed via the “Checklists complete” and “Begin work on checklist” action buttons on the master checklist document.

After the master checklist has obtained the “Complete” status, further editing of area checklists is possible only if the checklist status of the master checklist is first reset from “Complete” to “Work in progress”, and then the area checklists to be edited are reset to the draft status “Draft”.

According to another preferred version of the invention, the data which is entered using the checklists is exported into a relational database such as an Oracle database. This can happen periodically within specified time intervals or on request by a user. On the basis of the exported project data and using the relational database, a risk analysis is then carried out. Preferably, one or more specified risk analysis routines are executed and output in graphic presentations which are also specified.

It is particularly advantageous that according to the invention a hierarchical database is used for the distributed capture and control of the workflow for the data capture, whereas the actual risk analysis is carried out in a relational database. In this way, the project data which is required for the risk analysis can be collected efficiently, closely in time and at low transaction cost, because the hierarchical database can be adapted to the organisation of the company. On the other hand, the calculations and analyses which are required for risk analysis are carried out at a high processing speed, because for this a relational database such as Oracle is accessed.

A further advantage of the method according to the invention and the computer program according to the invention is that in principle all projects which are to be carried out or approved in a company or division are captured with their basic data (e.g., project management, employees, budget or time-scales). These projects can then be subjected to risk analysis on a case by case basis. The criteria for this can be, for instance, budget, duration or strategic importance. Further data collection is then required for these projects only.

Yet another advantage of the method according to the invention and the computer program according to the invention is the possibility of capturing costs per hour for employees and projects, and thus for the project portfolio, on the basis of the basic data which is captured for all projects which are handled in a company or division.

Preferred embodiments of the present invention are explained in more detail as follows and with reference to the drawing figures.

With reference to FIG. 1, in Step 100, a project is created. The basic data is entered in Step 102. These steps are carried out for all projects of a company or division. In this way the employees who do the project work are captured.

In Step 104, the basic data is checked for completeness and up-to-dateness.

In Step 106, there is a test for whether a risk analysis should be produced for the project. If not, the workflow ends here. Only the basic data is kept and updated in turn (Step 104). If a risk analysis is to be produced, the project master sheet is generated in Step 108. For each project, there is a project master sheet in which the project team members are defined.

In Step 110, the data is checked for completeness.

In Step 112, the master checklist is generated. Its initial status is “Work in progress”. In the master checklist, those who are responsible for the individual area checklists are selected from the list of project team members and stored. There is a master checklist for each subproject within a project. In the master checklist, dependencies between subprojects are defined.

In Step 114, the data is checked for completeness.

Then, in Step 116, the area checklists are generated. These have the initial status “Draft”. Each area checklist is specific to one company functional unit which is involved in the project, e.g. “research and development”, “regional/strategic marketing”, “production”, “patent law and licences” and “ecology”.

An area checklist includes input fields for entering data which is specific to the company functional unit to which the relevant area checklist is directed.

In Step 118, there is a test for whether the data of an area checklist is complete and up to date. If so, the status of the area checklist can be set to “Complete”.

In Step 120, there is a test for whether the status of all area checklists is set to “Complete”. If so, the status of the master checklist can be set to “Complete” (Step 122). Further editing of the area checklists is then no longer possible.

The various states of the area checklists and master checklist can be changed using action buttons of the relevant checklists:

Master Checklist

“Checklists Complete”

This button is visible only if the master checklist is in “Work in progress” document status and is open for editing. The checklist status of the master checklist is set from “Work in progress” to “Complete”. However, a precondition of this is that all area checklists are in “Document complete” document status.

“Begin Work on Checklists”

This button is visible only if the master checklist is in “Complete” document status and is open for editing. The checklist status of the master checklist is set from “Complete” to “Work in progress”.

Area Checklists

“Document Complete”

The document status is set from “Draft” to “Complete”. This button is displayed only in editing mode and in “Draft” document status of an area checklist.

“Draft Status”

The document status is reset from “Complete” to “Draft”. If the master checklist is already in “Complete” status, resetting to draft status is prohibited here. The button is displayed in both read and edit mode if the document is in “Complete” status.

For the case that an editor of an area checklist nevertheless considers that it is necessary to edit the entries in the area checklist for which the editor is responsible, Step 124 is provided. If the person who is responsible for the master checklist decides that further editing is necessary, in Step 126 the master checklist is reset to “Work in progress” status. In Step 128, the area checklist which is to be changed is reset to “Draft” status, so that the data entries can be edited. Steps 118 and 120 are then carried out again, to reset the master checklist to “Complete” status in Step 122 if appropriate.

If no more editing is required (Step 124), in Step 130 the entered data is exported to a relational database. For this purpose, there is a “Data export” action button on the master checklist. This causes a data export to a relational database such as Oracle.

For data export, four different variants must be distinguished:

(1) indirect export of a current version of a subproject on request (Version R)

(2) export of a current version of a subproject (Version A)

(3) export of an official version of a project (Version O)

(4) export of an official version of all projects (Version OA)

In the case of Variant (1), the data is exported to the relational database at the next run of the so-called Export Agent. The Export Agent may run, for example, once per hour (e.g., periodically and automatically). In the case of Variant (2), all current subprojects are exported to the relational database once within 24 hours. This may happen, for example, once per night.

In the case of Variant (3), an official version of a project is exported to the relational database when a button is pressed. In the case of Variant (4), all official versions of all projects are exported to the relational database when a button is pressed.

Once an export is started, it logs key data and at the end sends an e-mail, in which any errors in the running of the routine can be read back, to a mail-in database. A copy of all official projects which have been exported to the relational database is automatically “frozen in”, and the version number is increased by 1.

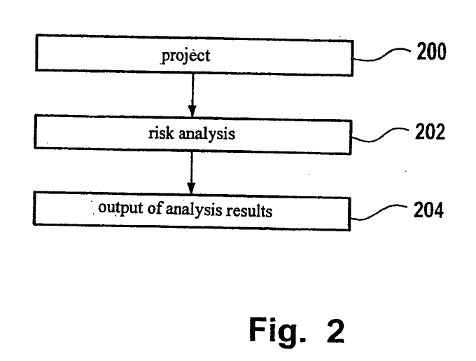

After the data is exported to the relational database, the risk analysis takes place. For this purpose, the project data which is stored in the relational database is accessed in Step 200 (see FIG. 2). On the basis of the project data, in Step 202 one or more specified risk analyses are carried out. The results are output graphically in Step 204.

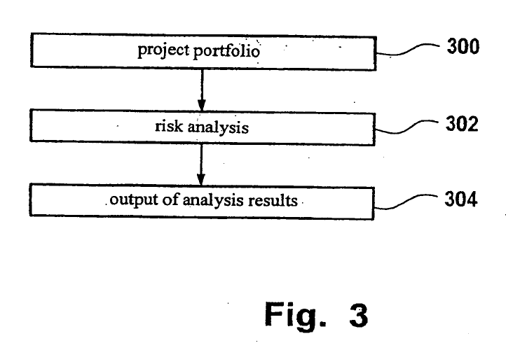

Alternatively, a risk analysis for a project portfolio can also be carried out. This is illustrated in FIG. 3.

In Step 300, a project portfolio is put together by selecting individual projects from a list. Next, the data which is stored in the relational database for the individual projects in the portfolio is accessed, to carry out a risk analysis for the project portfolio as a whole in Step 302. In Step 304, the analysis result is again output graphically.

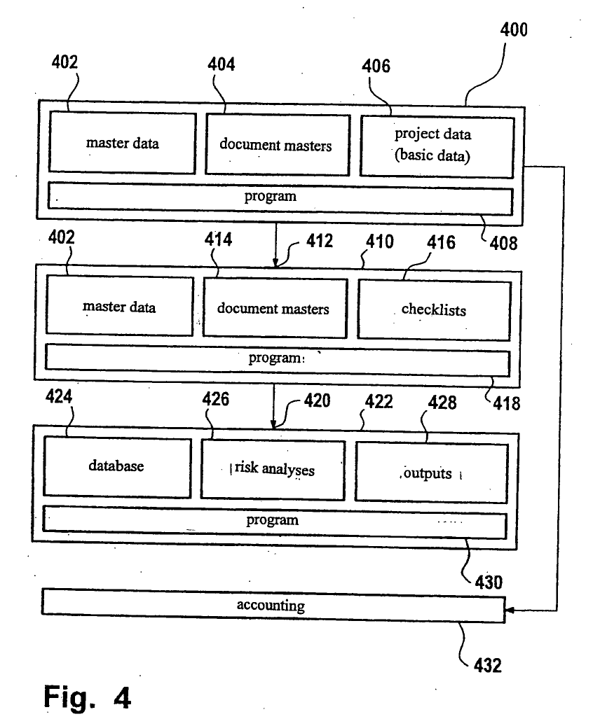

FIG. 4 shows a block diagram of a computer system according to the invention.

The computer system includes a subsystem 400 to capture the project data. For this purpose, a module 402 for storing master data, particularly that of the project team, is provided. A module 404 is used to store document masters. The module 406 is used to store basic data about projects in a hierarchical database. The program 408 is used to control the subsystem 400.

The subsystem 410 also accesses the module 402 to store master data. It has a further module (module 414) to store document masters to generate the master checklists and area checklists. The module 416 is used to store instances of area checklists and master checklists in a hierarchical database. The program 418 is used to control the subsystem 410 and to export the data from the hierarchical database to the relational database of the subsystem 422 via the interface 420.

The subsystem 422 for carrying out the risk analysis has a relational database 424, which is used for storing data which is exported from the subsystem 410. The subsystem 422 also has a module 426, which includes one or more specified routines for risk analysis. The module 428 is used to output the analysis results. The function of the subsystem 422 is controlled by the program 430.

The subsystem 400 is also linked to the accounting module 432, which is used for capturing costs to the nearest hour for employees and projects, and thus for the project portfolio as a whole.

Reference Symbol List

Subsystem 400

Module 402

Module 404

Module 406

Program 408

Subsystem 410

Module 414

Module 416

Program 418

Interface 420

Subsystem 422

Database 424

Module 426

Module 428

Program 430

Accounting module 432

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A method of performing a risk analysis for a project, comprising:
generating, in a hierarchical database, a plurality of area checklists in the form of documents, each area checklist having at least one input field, and entering data into said input field;
exporting the data from the hierarchical database to a relational database;
accessing the relational database, and performing said risk analysis on the data exported to said relational database; and
outputting risk analysis results for said project.

2. The method of claim 1 wherein each area checklist has an initial first status and a second status, the method further comprising:
generating, in said hierarchical database, a master checklist for the plurality of area checklists, said master checklist being in the form of a document and having an initial first status and a second status;
changing the initial first status of each area checklist to the second status of each area checklist when the data has been entered into the input fields of each area checklist; and
changing the initial first status of the master checklist to the second status of the master checklist when all area checklists have been changed to their second status.

3. The method of claim 2 further comprising the sequential steps of:
resetting the second status of the master checklist to the initial first status of the master checklist;
selecting at least one area checklist to be edited;
resetting the second status of each selected area checklist to the initial first status of each selected area checklist; and
editing the data in the input fields of each selected area checklist.

4. The method of claim 1 further comprising:
providing access to at least a first risk analysis routine and a second risk analysis routine;
performing said risk analysis by means of said first risk analysis routine and said second risk analysis routine; and
outputting graphically the risk analysis results.

5. The method of claim 1 wherein the export of the data from the hierarchical database to the relational database, and performance of the risk analysis are conducted one of (i) periodically and automatically, and (ii) upon request.

6. The method of claim 1 further comprising:
selecting a project portfolio comprising at least two of said plurality of area checklists;
accessing the data which belongs to the selected area checklists of said project portfolio;
performing a further risk analysis on the data which belongs to the selected area checklists of said project portfolio; and
outputting risk analysis results of said project portfolio.

7. A computer system for performing risk analysis of a project comprising:
hierarchical database resources for storing a plurality of area checklists in the form of documents, each area checklist having at least one input field into which data for risk analysis is entered;
relational database resources into which the data which has previously been entered in the input fields of the area checklists is exported and stored;
an export interface to export the data from the hierarchical database resources to the relational database resources; and
at least one risk analysis routine for risk analysis of the project on the basis of the data exported into the relational database, and from which a graphic output of the results of the risk analysis are generated.

8. The computer system of claim 7 further comprising:
a means of generating a master checklist for the plurality of area checklists in the form of a document of the hierarchical database, said master checklist having a having an initial first status and a second status, each of said area checklists having an initial first status and a second status;
a means of changing the initial first status of each area checklist to the second status of each area checklist when data has been entered into the input fields of each area checklist; and
a means of changing the initial first status of the master checklist to the second status of the master checklist when all area checklists have been changed to their second status.

9. The computer system of claim 8 further comprising:
a means of resetting the second status of the master checklist to the initial first status of the master checklist;
a means of resetting the second status of at least one area checklist to the initial status of the area checklist; and
a means of editing the data in the input fields of each area checklist having its initial status reset to its second status.

10. A computer program for risk analysis of a project comprising:
computer program resources for generating, in a hierarchical database, a plurality of area checklists in the form of documents, each area checklist having at least one input field into which data is entered;
computer program resources for exporting the data from the hierarchical database to a relational database; and
computer program resources for performing risk analysis on the data exported to said relational database.

11. The computer program of claim 10 further comprising computer program resources for performing the risk analysis one of (i) periodically, and (ii) upon request.

12. The computer program of claim 11 further comprising:
computer program resources for generating, in said hierarchical database, a master checklist for the plurality of area checklists, said master checklist being in the form of a document and having an initial first status and a second status;
computer program resources for changing the initial first status of each area checklist to the second status of each area checklist when the data has been entered into the input fields of each area checklist; and
computer program resources for changing the initial first status of the master checklist to the second status of the master checklist when all area checklists have been changed to their second status.

13. The computer program of claim 12 further comprising:
computer program resources for resetting the second status of the master checklist to the initial first status of the master checklist;
computer program resources for resetting the second status of at least one area checklist to the initial status of the area checklist; and
computer program resources for editing the data in the input fields of each area checklist having its initial status reset to its second status.

14. The computer program of claim 13 further comprising:
computer program resources for providing access to at least a first risk analysis routine and a second risk analysis routine;
computer program resources for performing said risk analysis by means of said first risk analysis routine and said second risk analysis routine; and
computer program resources for outputting graphically the risk analysis results.

15. The computer program of claim 10 wherein the computer program is stored on a digital storage medium selected from computer diskettes, CD-ROM's and semiconductor computer chips.
